(19) United States
(12) Patent Application Publication
(10) Pub. No.: US 2005/0056581 A1
(43) Pub. Date: Mar. 17, 2005

(54) System for recycling washing machine water

(76) Inventor: Timothy J. Arguello, Lakewood, CO (US)

Correspondence Address: LITMAN LAW OFFICES, LTD., P.O. BOX 15035 CRYSTAL CITY STATION, ARLINGTON, VA, 22215, US

(21) Appl. No.: 10/660,769

(22) Filed: Sep. 12, 2003

(51) Int. Cl. C02F 9/00; B01D 24/00

(52) U.S. Cl. 210/258; 210/259; 210/266

(57) ABSTRACT

Two systems of recycling washing machine effluent to irrigate fields in areas when natural precipitation and the municipal water supply are wanting. The pH is acidified from basic to 7 to 8 in a holding tank before the effluent flows through a series of ion exchange filters, treated with ultraviolet illumination, and to the irrigating water sprinklers and an inside or outside toilet.

### BACKGROUND OF THE INVENTION

1. Field of the Invention

The present invention relates to a system for recycling washing machine effluent or gray water for irrigation and for toilets by utilizing various rectifying apparatus and flow control devices.

2. Description of the Prior Art

The relevant art of interest describes various water purifying apparatus and methods, but none discloses the present useful invention. In Colorado there is a water shortage affecting the agricultural community, which problem can be resolved at least partially by recycling treated washing machine water to toilets and for irrigation purposes. The relevant art of interest will be discussed in the perceived order of relevance to the present invention.

U.S. Pat. No. 6,355,160 B1 issued on Mar. 12, 2002, for Cecil A. Wiseman et al. (hereafter referred to as Wiseman) describe a gray water recycling system for use in toilets and lawn care comprising a non-quantified reservoir 12 connected to an upper overflow pipe 17 presumed to be a sewer and an outlet pipe 16 which receives from dedicated pipe 76 water coming from wells, dams, rivers, or other sources of gray water. In other words, the system receives gray water from numerous other sources, whereas the instant system is designed for one household with its own household gray water recycling system. Conventional filtering means 20 is not further defined, whereas the present invention requires a series of filter stations including ion exchangers and/or column filters. In addition, an ultraviolet light station is included immediately downstream from the filter stations, which is neither suggested nor disclosed by the reference. An integral part of the reference's system is a first valve 24 (FIG. 2) containing a pressure sensor 33, two specially structured plugs 29 and 30, a conventional solenoid type switch 34 which receives fresh water from a dedicated line 67 (wells, dams, rivers, or other gray water) and feeds effluent to a pressure valve 52 (FIG. 3) and through a one-way valve 73 to the lawn watering system, a toilet, and recycled to the reservoir 12 along with gray water (FIG. 1). The main difference between the described Wiseman process and the instant process is the required recycling of the processed gray water back to reservoir 14 and the required use of the first valve 24 (FIG. 2) and the second pressure valve 52 (FIG. 3) having specific apparatus design and functional requirements. Most importantly, Wiseman is not concerned with any pH adjustment of the recycled water.

U.S. Pat. No. 5,106,493 issued on Apr. 21, 1992, for Todd McIntosh describes a gray water reclamation and reuse system comprising the collection of gray water from sources such a sink, a clothes washer, a shower stall, and a bathtub. The wastewater flows to a wastewater sump 12 having a level sensor, a first pump P1, a filter and back washer 104 to a holding tank 16 having a level sensor, and added chlorine pumped in. The treated gray water is pumped to a toilet and an outside hose connection. The system and process are distinguishable for receiving wastewater from the sink, shower stall, and bathtub as well as the clothes washer, and passing the gray water to a wastewater sump, whereas the present invention treats only sock-filtered washing machine effluent and does not require a sump.

U.S. Pat. No. 5,192,426 issued on Mar. 9, 1993, for Marc DeCoster et al. (hereafter referred to as DeCoster) describes a water reclamation system of gray water for landscape irrigation comprising the passing of a house's waste water from a bathtub, sinks, dishwasher, and clothes washer to a storage reservoir (above or below ground) from which a pump provides water to a filter, a check valve and the main irrigation line of sprinkler heads. The system is distinguishable for including effluent graywater from sinks, bathtub and dishwasher to include in the irrigation system.

U.S. Pat. No. 4,162,218 issued on Jul. 24, 1979, to Gerald L. McCormick describes a gray water reuse system comprising a 55 to 150 gallon holding tank having maximum and minimum float switches, to receive gray water from a kitchen sink, washing machine, bathroom sink, and tub-shower after passing through apparently filtering valves 23 A-D to separate solids to a sewer line and gray water. Gray water is filtered in the holding tank and pumped to a check valve, a solenoid valve, and a low-pressure switch to an optional pressure tank, and recycled to the bathroom stool and an outside faucet. The bathroom toilet discharge passes directly to the sewer line. The system is distinguishable for lacking ultraviolet exposure means and receiving effluent from other household appliances.

U.S. Pat. No. 4,228,006 issued on Oct. 14, 1980, to Daniel C. Hanna describes a domestic water system reclaiming waste water comprising passing gray water from a dishwasher, kitchen sink, and toilet directly to a sewer line while collecting gray water from a laundry tub, a clothes washer, a bathtub, a shower, and a wash basin to sunken clarifier tank which has an overflow pipe going to the sewer line and a bottom gray water output line going to a sump with an electric pump, three filter tanks and recycled to an outside hose, a hot water heater, and the aforementioned appliances and apparatus. The system is distinguishable for requiring the collection and recycling of gray water to the various aforementioned appliances and apparatus.

U.S. Pat. No. 4,812,237 issued on Mar. 14, 1989, to William E. Cawley et al. describes a closed water purification and recycle system processing domestic wastewater to produce potable water for cooking, drinking and dishwashing comprising the addition of fresh makeup water to a storage tank that pumps out the water to a pressurized (30 psig) tank 110 which supplies the water to a still and catch tank, the bathroom apparatus and the laundry. The still and catch tank also has a blow down to an incinerator toilet to convert the solids to ash for disposal. The still and catch tank also pumps water to a distilled water pressure tank and a kitchen sink and dishwater under 30 psig. The effluent from the kitchen appliances flows to a first septic tank and kept for 45 days before going to a second septic tank that receives nutrient from a supply tank and gray-water from the bathroom and laundry. The septic tank effluent is passed to a dosing tank and a biological coarse sand and gravel filter for aerobic degradation of organic materials. The effluent from the sand filter is passed to an ultra filter feed tank and also recycled to the dosing tank. The ultra filtered effluent is pumped to an ultra filter that divides its output to three different apparatus including a return to the laundry, a recycle to the ultra filter feed tank, and to an ultraviolet or chlorine disinfecting tank and to the storage tank. The system is distinguishable for requiring long retention in septic tanks, a large biological sand filter, and a still and catch tank.

U.S. Pat. No. 5,288,412 issued on Feb. 22, 1994, to Michael T. Voorhees et al. describes a modular gray water processing system comprising gray-water received from sinks, bathtubs, showers, and washing machines filtered by a charcoal filter to filter large particles of soap, toothpaste and the like. The filtrate is distributed by a fluid controller system to a plurality of ultraviolet radiation generating modules purifying the gray water at a rate as one gallon per minute per module and, stored in a storage tank for use by pumping for watering lawns or other undefined non-potable uses. The system is distinguishable for lacking a pressure regulator for controlling the water flow and requiring specially structured ultraviolet radiation generating modules.

U.S. Pat. No. 5,868,937 issued on Feb. 9, 1999, to Dwight D. Back et al. describes a process and system for recycling and reusing gray water generated by dishwashers, showers, carwashes, and clothes washers by utilizing hollow-fiber membrane ultra filtration. For a clothes washer, the gray water reuse or recycle system consists of a closed-loop water recycle that can be redirected to a storage tank (not shown) or directly used in situ with a clothes washer machine for subsequent rinse cycles. The process uses, at a minimum, 50% less water than conventional residential and commercial washers, and also decreases detergent requirements by 30% because a portion of the rinse water can be reused for subsequent wash cycles. In the first embodiment of FIG. 1, the effluent from a washing machine is pumped to an unidentified pre-filter, and a processing vessel containing a pump for passing to a drain and another pump for recycling the processed fluid to the washing machine. A spin motor or recycling pump passes the processed effluent to an ultra-filtration membrane cartridge and recycled either back to the processing vessel or to the washing machine with fresh water. The second embodiment in FIG. 6 illustrates a system wherein apparatus 18 and 19 are not explained for treating gray water issuing from a clothes washer, shower, dishwasher, and a car washer. The water flows into a gray water holding tank that passes the gray water to a filtration column and recycles the retentate solution to the holding tank. The permeate fluid from the filtration column is passed to a collection vessel, a conventional polishing apparatus or disinfecting unit (no examples) to obtain clean water for reuse in a clothes washer, et cetera. The systems are distinguishable for not requiring any ultraviolet radiation treatment.

Canada Patent Publication No. 2,020,824 published on Mar. 29, 1991, for Bradford G. Baruh describes an arrangement for reusing gray water comprising a system for sensing gray water in which a bathtub, shower stall, and self-contained toilet bowl are constructed with false bottom gray water collecting tanks for flushing a toilet bowl. A pump responsive to the level of the water in the flush tank is operated for conducting gray water into the flush tank. Rainwater advancing through wire mesh in downspouts may also be stored in the collecting tanks as gray water. The system is distinguishable for recycling rainwater and lacking any chemical treatment of the rainwater.

Korea Patent Publication No. KR9710082 published on Jun. 21, 1997, for Yu Bong-suk et al. describes a washing water reusing; apparatus attached to a washing machine comprising a microcomputer controlled system, storing used washing machine water in a reservoir attached to the washer, and adding the stored used water for the next wash. The system is distinguishable for recycling used washing machine effluent for the next washing operation without any chemical treatment.

World Intellectual Property Organization Patent Publication No. WO 97/33676 published on Sep. 18, 1997, for Steven F. Dellecave describes a gray water reclamation system comprising the reclaiming of gray water from the group of appliances including bathroom tubs, clothes washers, showers, kitchen sink, and washroom basin for reuse in toilets and outdoor irrigation. The black water from a second group of appliances includes toilets, dishwasher and garbage disposal is high in bacteria and is not reclaimed. The gray water is gravity filtered in a column holding a layer of sand separated by a mesh filter fabric from a bottom layer of gravel. The filtered gray water is stored in a tank having mist jets or air pumps for aeration. The gray water is filtered again to remove soap and passed to a sprinkler valve manifold or another activated carbon filter. Any excess gray water is passed to the sewer drain, and clean water is added to the tank when necessary. The system is distinguishable for requiring a gravity filter and mist jets or air pumps in the storage tank.

German Patent Publication No. DE 198 28 880 A1, published on Dec. 30, 1999, for Joachim Sopalla describes a water recycling system for gray water comprising the reclaiming of gray water from the group of appliances including bathroom tubs and sinks, showers, and washroom basin. The black water from a second group of appliances includes toilets, kitchen sink, and garbage disposal is high in bacteria and is not reclaimed. The gray water is filtered, stored in a tank, excess gray water being passed to the sewer drain, and clean water is added to the tank when necessary. The system is distinguishable for being limited to the mere filtering of gray water for reuse.

None of the above inventions and patents, taken either singly or in combination, is seen to describe the instant invention as claimed.

### SUMMARY OF THE INVENTION

The present invention is a solution to a water shortage problem existing in Colorado causing the landscape industry to lose its usual business.

The present invention is directed to two embodiments of a system for utilizing washing machine effluent (gray water) to provide water for inside and outside toilets and irrigation of plants in the backyard or field. The system includes a computerized control board posted on an inside wall, organic ion exchange resins and/or activated carbon filters and strainers, a supply line with solenoid valves for separate outlets, a ball valve, check valves, pressure gauges, a 50-gallon storage tank, an ultraviolet light lamp, and a sprinkler timer. A biodegradable soup or vinegar is added to acidify the basic gray water to a pH of 7 to 8 in the storage tank. The plumbing line is made of either polyvinyl chloride or copper.

Accordingly, it is a principal object of the invention to provide a computerized recycling system for gray water by purifying effluent from a washing machine to supply water for irrigation and inside and outside toilets.

It is another object of the invention to provide a computer controlled recycling system for chemically treating and filtering the gray water with a series of ion exchange resins or activated carbon filters.

It is a further object of the invention to provide the treatment of the gray water with ultraviolet radiation.

Still another object of the invention is to provide a plumbing line of either polyvinyl chloride or copper.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a schematic diagram of a first embodiment of a system for a washing machine effluent recycled to the irrigation sprinkler system and an outside toilet.

FIG. 2 is a schematic diagram of a second embodiment with a different filtering system and solenoid valve control of rocessed gray water to the outside toilet and sprinkler system.

Similar reference characters denote corresponding features consistently throughout the attached drawings.

### DETAILED DESCRIPTION OF THE PREFERRED EMBODIMENT

The present invention is directed to apparatus and two methods for recycling gray water from a washing machine effluent that includes all the water utilized to wash with a detergent, rinse, and drip-dry the clothes.

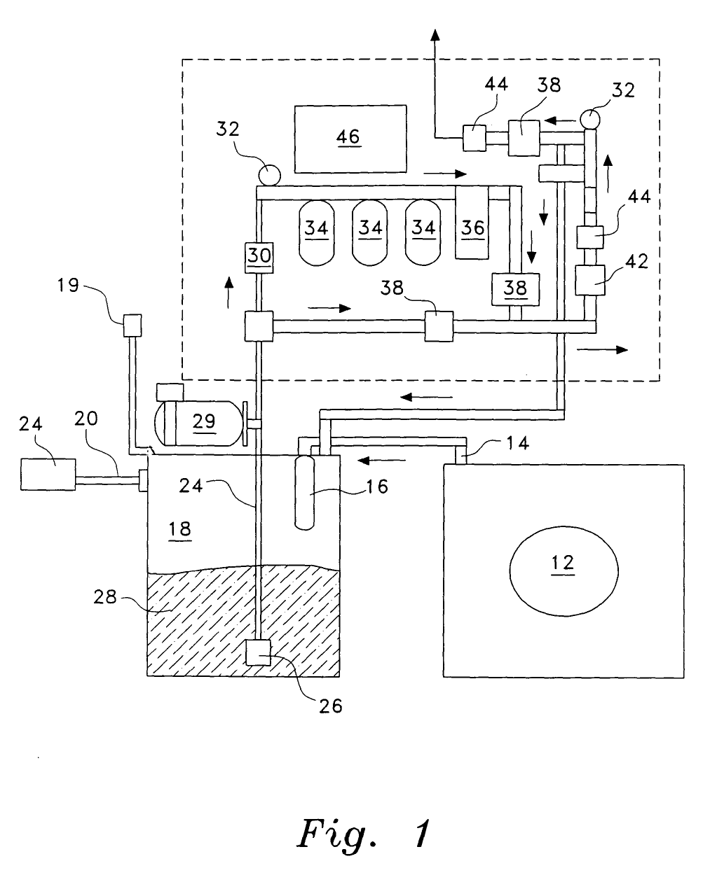

In FIG. 1, the apparatus 10 begins with the effluent gray water leaving the washing machine 12 through the discharge hose 14 and a filter sock 16 into a vented 55-gallon drum or holding tank 18 having vent 19, wherein the pH is adjusted to between 7 and 8 by either a biodegradable soup (preferred), vinegar or acetic acid. The filter sock 16 can be a female nylon hose and the like. An overflow conduit 20 is located proximate the top surface of the tank 18 and directed at a 10 to 15 degree angle downward for gravity flow to a wall drain 22 and an optional suitable receptacle. The pipes in this system can be either polyvinyl chloride or copper.

A vertical suction tube 24 centered inside the tank 18 ends in a check valve 26 to insure one-way flow of the stored gray water 28 into the recycling system. A 2 to 100 psi (50 psi preferred) producing switch pump 29 then forces the gray water through a pressure regulator device 30 and a pressure gauge 32 to a series of filters 34 (three filters preferred) in line to filter out any remaining particles that passed through the filter sock 16. The filters 34 can constitute an organic ion exchanger resin and/or activated carbon. An ultraviolet light source 36 kills any harmful bacteria present in the gray water. A first zone shutoff valve 38 is available to close the flow in the pipe.

Returning to the gray water flow from the holding tank 18, an unrestricted bypass flow path is utilized at the pipe junction 40 to balance the total flow from the holding tank 18. This bypass flow passes through another zone shutoff valve 38 to join the filtered and purified gray water flowing from the filters 34 and the ultraviolet light source 36. The combined gray water passes through a check valve 42 for one-way flow and a second ball valve 44 to a pressure gauge 38 and another zone valve 38 to a third ball valve 44. At this point piping is provided for recycled clean gray water to either an outside toilet (not shown) or a sprinkler system (not shown) controlled by a sprinkler timer 46. It should be noted that the apparatus enclosed within the dashed rectangle constitutes the control unit that can be wall mounted.

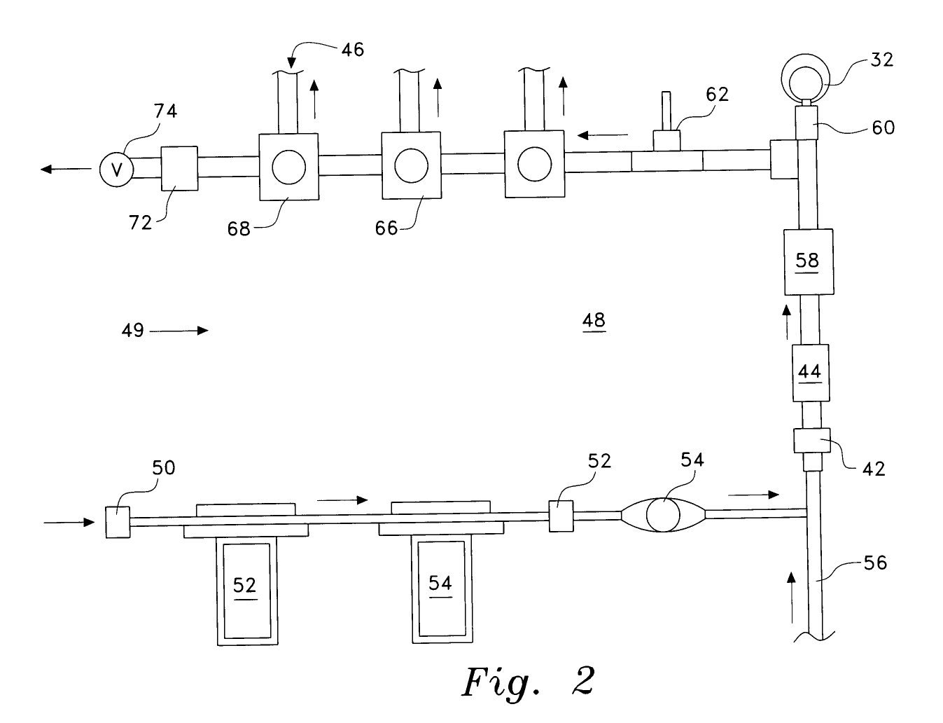

In FIG. 2, a layout of a control board 48 for a second embodiment of control of partial apparatus 49 is illustrated. It should be understood that a microcomputer (not shown) is the basic controller of all the elements in the apparatus 10 as well as apparatus 49. However, manual manipulation of the various valves can be performed. The control board 48 shows the gray water supply line 50 feeding the gray water from the washing machine flowing through the strainer or filter sock 16, filters 34 (only one collective symbol shown), an ultraviolet ray radiator device 52, and an optional water flow meter 54. The treated gray water supply joins the unrestricted and untreated supply line 56 to pass through the check valve 42, ball valve 44, a water pressure switch 58, a manifold 60 having a pressure gauge 32, an optional low level controller device 62, a first solenoid valve 64 to control the flow to the outside toilet (not shown), a second solenoid valve 66 for controlling the flow of recycled gray water to the sprinkler system and timer (not shown), a third solenoid valve 68 adapted for supplying processed gray water for any other purpose, a standard gray water reservoir 70 utilizing a conventional 8-20 psi mist or drip device for further aerobic purification, a zone valve 72, and a drain valve 74.

It is to be understood that the present invention is not limited to the sole embodiment described above, but encompasses any and all embodiments within the scope of the following claims.

1. A microcomputer controlled system for recycling washing machine gray water effluent to irrigation and an outside toilet comprising:
a microcomputer for controlling the recycling system;
a large gray water tank having a discharge hose attached to a washing machine's drain hose ending in a filter sock inside the tank;
a vertical suction tube having an external switch pump;
a pipe leading from the pump bifurcating to form a restricted flow branch pipe and an unrestricted flow branch pipe;
a pressure regulator device on said restricted flow branch pipe;
at least three in-line chemical filters for filtering restricted flow gray water;
an ultraviolet radiation device radiating the filtered gray water; and
a conduit passing the filtered radiated gray water to an outside toilet and to a water sprinkler system.

2. The gray water recycling system according to claim 1, wherein the tank is a fifty-five gallon drum located adjacent to the washing machine.

3. The gray water recycling system according to claim 1, wherein a one-way check valve is positioned at an inlet of the vertical suction tube.

4. The gray water recycling system according to claim 1, wherein the unrestricted flow branch pipe conducts gray water to a zone valve and joins the filtered and radiated gray water stream.

5. The gray water recycling system according to claim 1, wherein the tank has an overflow drain pipe inclined downward 10 to 15 degrees.

6. The gray water recycling system according to claim 1, wherein the in-line filters are selected from the group consisting of ion exchange resin, activated carbon and mixtures thereof.

7. The gray water recycling system according to claim 1, wherein the pH of the gray water inside the tank is adjusted to a range of 7 to 8 by an acidic reagent selected from the group consisting of a biodegradeable soup, vinegar and acetic acid.

8. The gray water recycling system according to claim 7, wherein the pH is adjusted by addition of a biodegradable soup.

9. The gray water recycling system according to claim 7, wherein the pH is adjusted by addition of either vinegar or acetic acid.

10. A system for recycling washing machine gray water effluent to irrigation and an inside/outside toilet comprising:
a microcomputer for controlling the system;
a large gray water tank having a discharge hose attached to a washing machine's drain hose ending in a filter sock inside the tank;
a vertical suction tube having an external switch pump;
a pipe leading from the pump to a filter and a strainer in line;
an ultraviolet radiation device irradiating the filtered gray water;
an unrestricted gray water supply line joining the filtered and irradiated gray water supply line;
a pressure switch measuring and adjusting the pressure of the supply line;
a manifold and a pressure gauge;
a supply pipe positioned from the manifold to a supply line having a series of solenoid valves for controlling the supply of treated gray water to the inside toilet and outside devices;
a reservoir containing an 8 to 20 psi mist or drip device; and
a drain valve for controlling the level of the treated gray water.

11. The gray water recycling system according to claim 10, wherein the tank is a fifty-five gallon drum located adjacent to the washing machine.

12. The gray water recycling system according to claim 11, a one-way check valve is positioned at an inlet of the vertical suction tube.

13. The gray water recycling system according to claim 11, wherein the tank has an overflow drain pipe inclined downward 10 to 15 degrees.

14. The gray water recycling system according to claim 11, wherein the gray water from the tank flows through a filter.

15. The gray water recycling system according to claim 14, wherein the filter is selected from the group consisting of an organic ion exchange resin and an activated carbon.

16. The gray water recycling system according to claim 15, wherein the filter is an organic ion exchange resin.

17. The gray water recycling system according to claim 15, wherein the filter is activated carbon.

18. The gray water recycling system according to claim 11, wherein a water meter is inserted in the gray water line after the ultraviolet radiation device.

19. The gray water recycling system according to claim 11, wherein a low-level controller device is inserted in the gray water line between the solenoid valves and the manifold.

20. The gray water recycling system according to claim 11, wherein the outside devices are an outside toilet and a water sprinkler system.
